(19) United States
(12) Patent Application Publication
(10) Pub. No.: US 2016/0066608 A1
(43) Pub. Date: Mar. 10, 2016

(54) POTATO SALAD MIX

(71) Applicant: Jeffery M. Meyer, Oconomowoc, WI (US)

(72) Inventor: Jeffery M. Meyer, Oconomowoc, WI (US)

(21) Appl. No.: 14/476,913

(22) Filed: Sep. 4, 2014

(51) Int. Cl. A23L 1/223; A23L 1/24; A23L 1/216; A23L 1/221

(52) U.S. Cl. CPC A23L 1/223; A23L 1/2212; A23L 1/24; A23L 1/216; A23V 2002/00

(57) ABSTRACT

A dry spice/herb mixture usable for being admixed with a cooked food, preferably potatoes, comprises a plurality of base ingredients including celery seeds, garlic granules, onion powder, paprika, and turmeric. The base ingredients are also combined with sugar which constitutes the major bulk of the dry spice/herb mixture. Flavor enhancers can be used including minced onion, mustard seed, dill weed, parsley flakes and black pepper. The dry spice/herb mixture is preferably combined with real mayonnaise and optionally white vinegar, chilled and then admixed with cooked and chilled potatoes to obtain a final potato salad product.

### BACKGROUND OF THE INVENTION

The present invention relates, in general, to food products and, more particularly, to dry spice/herb blends or mixtures for preparing potato and like salads and to methods of using the blends in the preparation of potato and like salads.

In general, the objective of the present invention is to provide a dry mixture of spices and herbs and methods for using them for preparing potato salads that are consistently creamy and tasty and that have an aesthetically appealing color and texture and are exceedingly simple to prepare even by inexperienced cooks.

There are numerous mixes and recipes for potato salads including Taco Seasoning Mixes, Sloppy Joe Mixes, Chili Seasoning Mixes, Dill Dip Mixes, Vegetable Dip Mixes, Salad Dressing Mixes, Roasted Potato Seasonings, Gravy Mixes and many more. In the prior art, it has been attempted to provide a recipe using dehydrated potatoes in a chemically invasive mix of ingredients that would be cooked like macaroni and cheese, but it was unsuccessful and ranked very poorly in the food world. Based upon an extensive search, the present inventor has determined that there has not yet been one potato salad mix that a consumer can easily add to their choice of food medium or starches.

The invention's general objective is to provide a wholesome, all-natural, no preservatives, no additives, creamy and delicious food/procedure item that could be in everyone's pantry similar to the ones listed above, but with a superior taste that is consistently obtained every time the recipe is used and does not result in a gravy-like coating on the potatoes, but rather in a creamy, rich, luxurious finish.

The patent literature discusses potato products including potato salad recipes as reflected by U.S. Patent Application Publication Nos. US 2007/0065569 and US 2007/0148322. The inventor notes that the process of preparing a potato salad is not as intuitive as one would expect. First, most people experience their grandmothers' or mothers' version and gravitate to that being the standard potato salad. Traditionally, preparing homemade potato salad is a labor of love for home style cooking. Dicing, measuring, mixing and creating the entire recipe from scratch is very time consuming. Trial and error often plays a role in making a meal a flavorful delight. Too much of any one ingredient can overpower and ruin the flavor of the potato salad. Too little of any one ingredient can lead to a bland potato salad taste. With all the work that is involved in preparing the potato salad, the cook would like the potato salad to be appreciated when it is eaten by family or guests. Therefore, it is desirable and beneficial to provide to home based cooks an ability to prepare for their families and guests a potato salad that is consistent in taste, always delicious and creamy and never subject to the vicissitudes of the food preparation process and, even more importantly, is overwhelmingly delicious and far more tasty than the expected “normal” potato salad.

### SUMMARY OF THE INVENTION

Accordingly, it is an object of the present invention to provide a potato salad dry mix that is easy to use and which produces a creamy potato salad that is not thick, nor starchy, nor one which has a gravy-like consistency, yet still retains all the spices' flavors.

It is another object of the present invention to provide a potato salad spice/herb mix that is provided in sealed packets with long shelf lives.

It is yet another object of the present invention to provide a method for using the spice/herb dry mix of the invention to produce a very tasty potato or like salad.

It is still another object of the present invention to provide a recipe for potato salad that uses a dry mix of spices and herbs and which can be utilized to produce a potato salad into which other ingredients of choice or preference can be added such as chopped carrots, eggs and the like.

The foregoing and other objects of the invention are realized by a spice and herb blend/mixture which is provided in dry form and which preferably includes at least celery seeds, garlic granules, onion powder, paprika, turmeric and salt. These basic flavoring ingredients are preferably combined with cane sugar which comprises the bulk of the dry mixture. In accordance with preferred embodiments, other flavor enhancing ingredients can be provided such as minced onion, mustard seeds, dill weed, parsley flakes, and celery seeds in various proportion as more specifically described further on.

In accordance with a preferred embodiment of the invention, a packet of the spice/herbs blend is admixed with a cup of real mayonnaise and one teaspoon of white vinegar which are then blended, mixed well and chilled, obtaining a ready to use mix paste. Potato morsels are cooked sufficiently to become soft and delicious within and are then rinsed and cooled to room temperature before mixing the above chilled mix paste and the potatoes together. It is preferred to allow the potato salad flavoring mix and the cooled potatoes combination to chill for at least an hour before serving.

Other features and advantages of the present invention will become apparent from the following description of the invention that refers to the accompanying drawings.

### DETAILED DESCRIPTION OF PREFERRED EMBODIMENTS OF THE INVENTION

In one main form thereof, the invention comprises a packet of ingredients which essentially consist of spices and herbs mixed together in a dry mix format. The packet is essentially sealed in preferably a 4″×5″ polypropylene bag which provides it with a long shelf life. The preferred contents of the spice packet are described further on below.

In accordance with a preferred embodiment of the invention, the process/recipe for preparing the actual food product comprises the following steps:

Step 1—(a) Combine the contents of one spice packet with one (1) cup of real mayonnaise (or preferred medium, i.e., Greek yogurt, yogurt, Vegannaise, etc.) and one (1) teaspoon of white vinegar (optional) and (b) mix well and place into refrigerator to chill. This allows the oil of the spices to dissolve within the medium of choice to enhance the flavor of the mixture. The mayonnaise or other preferred means noted above is what is referred to herein as the “base cream,” or “mix paste.”

Step 2—Starting with 2.5 pounds of baby red potatoes (or other preferred potato choice), clean and rinse while leaving the skins on, and chop to where the pieces of the potato are roughly the size of a nickel to quarter, to ensure that at least three sides of the potato morsel are exposed. This ensures the absorption of the spice blend medium (chilled mayo, yogurt, etc.) into the potato morsels.

Step 3—Add the potato morsels to a pot of water, ensuring at least one inch of water coverage above the potatoes. Set stovetop to HIGH, bring water to boil (approximately 212° F.), then start time for 5-8 minutes, testing periodically with a fork to ensure the potatoes are cooked to a firm yet tender consistency. Do not over cook. The inventor has found that starting the time after the water reaches the boiling point ensures the texture of the potato morsels to be the desired consistency required to adequately absorb the spice blend/mixture.

Step 4—Once the potatoes are cooked, remove from stovetop and empty potato morsels into a colander to drain thoroughly. Proceed to rinse the potato morsels with cold water until morsels reach near room temperature. This also removes excessive starches from the surface of the morsels. This part of the process results in creating the creamy consistency of the product due to the removal of the starches and residual heat of the uncooled potatoes, which if not done, causes a very undesirable gravy-like consistency; not the creamy, rich, luxurious finish of the product(s) of the present invention.

Step 5—Retrieve the previously prepared spice blend/mixture from the refrigerator and combine the cooled potato morsels and the spice blend, and mix thoroughly together which produces the creaminess of the spice blend product and potatoes. Even though at this point this product would be ready to enjoy, the inventor recommends chilling for an additional 1-2 hours before consumption, for a more thorough absorption of the spice blend into the potatoes.

Based on extensive experimentation, the instant inventor has evolved a spice/herb blend with many different ingredients that are listed in the table below, indicating the most favorite and preferred percentage contents for the different ingredients. Other columns provide acceptable variations on those percentages, with the rightmost column indicating the percentage ranges applicable to the “percentages” and/or “percentage ranges” columns.

| | | | | Percentage | Percentage Range |
|---|---|---|---|---|---|
| Ingredients | Grams (g) | | Percentages | Ranges | Tolerances |
| Cane Sugar | 28.36 | | 55.8 | 50-60 | +/−15% |
| Minced Onion | 7.85 | | 15.5 | 10-20 | +/−15% |
| Salt | 4.47 | | 8.8 | 5-15 | +/−15% |
| Mustard Seed | 3.0 | | 5.9 | 3-9 | +/−15% |
| Dill Weed | 2.56 | | 5.1 | 4-10 | +/−15% |
| Parsley Flakes | 1.74 | | 3.4 | 2.5-5 | +/−15% |
| Celery Seeds | 0.65 | | 1.3 | .5-3 | +/−15% |
| Black Pepper | 0.63 | | 1.2 | 1-3 | +/−15% |
| Garlic Granules | 0.55 | | 1.1 | .5-3 | +/−15% |
| Onion Powder | 0.39 | | 0.77 | .1-3 | +/−15% |
| Paprika | 0.38 | | 0.73 | .1-3 | +/−15% |
| Turmeric | 0.22 | | 0.40 | .1-1.0 | +/−15% |
| Total | 50.80 | (g) | 100.0% | | |
| Composition | | | | | |

In accordance with the inventor's discovery, the basic spice/herb mixture should include the following ingredients: celery seeds, garlic granules, onion powder, paprika, turmeric and salt. The onion and salt will be mixed preferably with the cane sugar, or other sugars. The onion powder acts primarily as a binding agent that binds the other ingredients. The remaining ingredients such as the minced onions, the mustard seed, the dill weed, the parsley flakes and the celery seeds are taste complimenters and enhancers. For the black pepper, the inventor prefers a coarse ground, for example, 28 mesh black pepper. The parsley flakes acts as a filler and coloring agent. The paprika also adds color. The aforementioned ingredients act as a base for the mixture.

The spices and herbs of the inventive potato salad mix are all organic and gluten-free by nature and certified by appropriate agencies, i.e., MOSA, whereby a consumer can add this mix to whatever medium (real mayonnaise, Vegan mayonnaise, Greek and non-Greek yogurt, etc.) and then choose their preferred starches to combine with, for example, baby red potatoes, Yukon gold, noodles, etc., to suit individual needs and requirements. The spice blend of the invention results in a superiorly tasting food product when used with organic spices and herbs. By using the spice mix of the invention and preparing the ultimate food product in accordance with the invention, one is assured of obtaining a potato salad that is easily prepared with a consistent, creamy and delicious flavor.

It is also noted that the packet of spices/herbs in accordance with the invention can be used in soup stock, marinades, steak rubs and other food flavor-enhancing uses. It is noted that by placing the combined food packet blend with the mayonnaise and white vinegar, particularly after letting the mix to chill for at least an hour before serving, one obtains a marinating effect whereby the mixed flavor and taste is deeply absorbed within the potato stock, thereby even if the potato stock were to be rinsed, the intense and delicious flavor absorbed within remains.

It is also noted that the inventive spice/herb blends of the present invention can be combined with many assortments of fresh or even canned potatoes, baby red potatoes, Yukon gold, or any other potatoes. The inventor herein is aware that using canned potatoes (difficult to find and more expensive than fresh) one can make the product work due to the elimination of needing to boil the potatoes. Without having to boil the potatoes, there would be no heat in the potatoes that would produce a gravy-like texture (instead of being creamy) which is undesirable in potato salad.

The food products described herein can be certified as being organic, kosher, gluten-free to meet commercial requirements.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A dry spice/herb mixture for admixing with a food, the dry spice/herb mixture comprising:
(a) a plurality of base ingredients including celery seeds, garlic granules, onion powder, paprika, and turmeric; and
(b) sugar, wherein said sugar comprises at least five times the combined weight of the celery seeds, garlic granules, onion powder, paprika and turmeric.

2. The dry mixture of claim 1, further including salt.

3. The dry mixture of claim 2, wherein said sugar is cane sugar.

4. The dry mixture of claim 2, wherein the percentage weights of said plurality of base ingredients in said dry spice/herb mixture including celery seeds, garlic granules, onion powder, paprika and turmeric and of said sugar are, respectively 0.5-3.0; 0.5-3.0; 0.1-3.0; 0.1-3.0; 0.1-1.0; and 50-60.

5. The dry herb/spice mixture of claim 4, wherein said percentage weight of said celery seeds, garlic granules, onion powder, paprika, turmeric and sugar are about 1.3; 1.1; 0.77; 0.73; 0.4; and 55.8, where each percentage is to be taken to a tolerance of +/−15%.

6. The dry herb/spice mixture of claim 4, wherein said dry mixture is stored in a sealed bag.

7. The dry herb/spice mixture of claim 4, further including at least three of the following enhancing ingredients: minced onion, mustard seed, dill weed, parsley flakes, and black pepper.

8. The dry herb/spice mixture of claim 4, further including at least four of the following enhancing ingredients: minced onion, mustard seed, dill weed, parsley flakes, and black pepper.

9. The dry herb/spice mixture of claim 4, further including minced onion, mustard seed, dill weed, parsley flakes, and black pepper.

10. The dry herb/spice mixture of claim 4, wherein a percentage weight of said minced onion, mustard seed, dill weed, parsley flakes and black pepper is, respectively, 10-20; 3-9; 4-10; 2.5-5 and 1-3, each to a tolerance of +/−15%.

11. The dry herb/spice mixture of claim 4, in combination with the food, said food comprising one of potatoes, Greek yogurt, yogurt, Vegannaise, baby red potatoes, Yukon gold, and noodles.

12. A method of using the dry mixture of claim 1 to prepare a starch-based food comprising the steps of:
combining the dry mixture with a base paste to create a creamy mix paste;
cooking a starch food to an edible phase and thereafter, allowing the starch food to cool to about room temperature; and
mixing the starch food with the mix paste to obtain a final starch-based food.

13. The method of the claim 12, wherein the starch food is potatoes and further including rinsing the potatoes after their cooking to cool them down to about room temperature.

14. The method of claim 13, wherein the base paste comprises at least one of real mayonnaise, Greek yogurt, yogurt, and Vegannaise.

15. The method of claim 14, wherein the mix paste also comprises white vinegar.

16. The method of claim 13, including placing the final starch-based food for about one to two hours in a refrigerator to further cool the mixture.

17. The method of using the dry mixture of claim 1 as one of:
a soup stock, a marinade and a steak rub.
